(19) United States
(12) Patent Application Publication
(10) Pub. No.: US 2024/0176026 A1
(43) Pub. Date: May 30, 2024

(54) ILLUMINATION CIRCUITRY, ILLUMINATION METHOD, TIME-OF-FLIGHT MODULE

(71) Applicant: Sony Semiconductor Solutions Corporation, Atsugi-shi, Kanagawa (JP)

(72) Inventors: Nicolangelo LOPEZ, Stuttgart (DE); Luc BOSSUYT, Stuttgart (DE); Camille GIAUX, Stuttgart (DE); Victor BELOKONSKIY, Stuttgart (DE)

(73) Assignee: Sony Semiconductor Solutions Corporation, Atsugi-shi, Kanagawa (JP)

(21) Appl. No.: 18/280,952

(22) PCT Filed: Mar. 4, 2022
(86) PCT No.: PCT/EP2022/055535

§ 371 Date: Sep. 8, 2023

(30) Foreign Application Priority Data
Mar. 15, 2021 (EP) 21162624.7

(51) Int. Cl. G01S 17/894; G01S 7/484; G01S 7/4865

(52) U.S. Cl. CPC G01S 17/894; G01S 7/484; G01S 7/4865

(57) ABSTRACT

An illumination circuitry for a time-of-flight module for switching at least two illuminators, wherein the illumination circuitry is configured to: receive an input illumination signal from a time-of-flight sensor; and generate, based on the input illumination signal, synchronized first illumination signals for a first illuminator and second illumination signals for a second illuminator.

### TECHNICAL FIELD

The present disclosure generally pertains to an illumination circuitry and an illumination method for switching at least two illuminators and a time-of-flight module with switchable illumination for a scene.

### TECHNICAL BACKGROUND

Generally, time-of-flight (ToF) systems are known, which are typically used for determining a distance to objects in a scene or a depth map of (the objects in) the scene that is illuminated with light.

Basically, two different techniques for the distance measurement are known: direct ToF (“dToF”) and indirect ToF (“iToF”). In dToF systems, the distance is determined based on a time-of-arrival of a light pulse reflected at objects in the scene. In iToF systems, the scene is illuminated with a modulated light wave and a phase difference between emitted and reflected light wave is indicative for the distance.

Moreover, two different types of illumination are known: full-field illumination and spotted illumination. With full-field illumination, the scene is illuminated with a continuous spatial light profile. For example, a light beam which has a high-intensity area in the center of the light beam with a continuously decreasing light intensity away from the center of the light beam. With spotted illumination, the scene is illuminated with a plurality of light spots.

Although there exist techniques for time-of-flight modules, it is generally desirable to improve the existing techniques.

### SUMMARY

According to a first aspect the disclosure provides an illumination circuitry for a time-of-flight module for switching at least two illuminators, the illumination circuitry being configured to:
receive an input illumination signal from a time-of-flight sensor; and
generate, based on the input illumination signal, synchronized first illumination signals for a first illuminator and second illumination signals for a second illuminator.

According to a second aspect the disclosure provides an illumination method for a time-of-flight module for switching at least two illuminators, the illumination method comprising:
receiving an input illumination signal from a time-of-flight sensor; and
generating, based on the input illumination signal, synchronized first illumination signals for a first illuminator and second illumination signals for a second illuminator.

According to a third aspect the disclosure provides a time-of-flight module with switchable illumination for a scene, comprising:
a time-of-flight sensor configured to generate time-of-flight data representing a time-of-flight measurement of light reflected from the scene and to output an illumination signal for controlling the illumination for the scene;
an illumination circuitry configured to:
   receive the illumination signal from the time-of-flight sensor,
   generate, based on the illumination signal, synchronized first illumination signals for a first illuminator and second illumination signals for a second illuminator;
the first illuminator configured to:
   receive the first illumination signals,
   provide, based on the first illumination signals, the full-field illumination to the scene; and
the second illuminator configured to:
   receive the second illumination signals,
   provide, based on the second illumination signals, the spotted illumination to the scene.

Further aspects are set forth in the dependent claims, the following description and the drawings.

### BRIEF DESCRIPTION OF THE DRAWINGS

Embodiments are explained by way of example with respect to the accompanying drawings, in which:

FIG. 1 schematically illustrates in a block diagram an embodiment of a time-of-flight module;

FIG. 2 schematically illustrates in FIG. 2A in a block diagram a first embodiment of an illumination circuitry and in FIG. 2B in a timing diagram a signal timing of the first embodiment of the illumination circuitry;

FIG. 3 schematically illustrates in a block diagram a second embodiment of an illumination circuitry; and

FIG. 4 schematically illustrates in a flow diagram an embodiment of an illumination method.

### DETAILED DESCRIPTION OF EMBODIMENTS

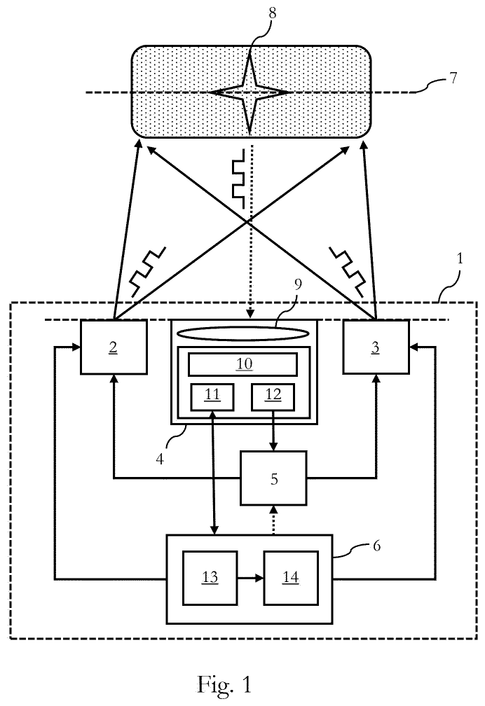

Before a detailed description of the embodiments under reference of FIG. 1 is given, general explanations are made.

As mentioned in the outset, basically, two different time-of-flight (ToF) distance measurement techniques are known, which are used in some embodiments: direct ToF (“dToF”) and indirect ToF (“iToF”).

In dToF systems, in some embodiments, the distance is determined based on a time-of-arrival of a light pulse emitted by an illuminator towards a scene where the light pulse is at least partially reflected at objects in the scene. A time between two consecutive light pulses is typically divided into time intervals with equal spacing. In such embodiments, time-of-flight data (ToF data) is generated by a time-of-flight sensor (“ToF sensor”) in the form of a histogram for each pixel of the ToF sensor. The histogram represents a number of events (e.g. detected photons) arrived in a particular time interval. This process may be repeated several times to increase a signal-to-noise ratio.

In iToF systems, in some embodiments, the scene is illuminated with a modulated light wave and a phase difference between emitted and reflected light wave is determined which is indicative for the distance. In some embodiments, ToF data is generated by a ToF sensor corresponding to four frames with different phase shifts (e.g. 0°, 90°, 180° and 270°) between an illumination signal applied to an illuminator and a demodulation signal generated in the ToF sensor and applied to a plurality of pixels in the ToF sensor. In such embodiments, the ToF data includes pixel values of the plurality of pixels of the ToF sensor of the four frames. Based on the captured four frames, component data (IQ values: Q is quadrature component, I is in-phase component) may be calculated. In some embodiments, ToF data includes component data.

Furthermore, in some embodiments also other technologies may be used or even combined. For instance, spotted ToF may be used, wherein a distance is determined based on the deviation of a spot pattern reflected by an object.

Moreover, as also mentioned in the outset, basically, two different types of illuminators with different illumination profiles are known, which are used in some embodiments: full-field illuminators and spot illuminators.

The full-field illuminator, in some embodiments, provides a full-field illumination to a scene such that the scene is illuminated with a continuous spatial light profile. For example, a light beam which has a high-intensity area in the center of the light beam with a continuously decreasing light intensity away from the center of the light beam.

The spot illuminator, in some embodiments, provides a spotted illumination to a scene such that the scene is illuminated with a plurality of light spots. In other words, the scene is illuminated with a light pattern of (separated) high-intensity and low-intensity (or substantially zero-intensity) areas such as, for example, a pattern of light spots (e.g. light dots). In some embodiments, the spot illuminator provides a spatially modulated light field-of-illumination (light pattern) with vertical or horizontal stripes or with a checker pattern. Generally, in some embodiments, the spot illuminator provides a spatially modulated field-of-illumination (light pattern) to a scene where a light intensity is low (or substantially zero) in part of the light pattern.

Typically, the illumination signal applied to the illuminator (and the demodulation signal applied to the ToF sensor) is generated in the ToF sensor and output to the illuminator via a control channel. For example, the ToF sensor includes a timer for outputting the illumination signal which allows to control the illuminator by the ToF sensor. Thus, typical ToF sensors may only have one control channel for controlling one illuminator.

The illumination signal generated in the ToF sensor may be based on a (high-frequency) modulation signal corresponding to the (high-frequency) demodulation signal generated in the ToF sensor. The modulation signal may be gated with an illumination gating signal or an illumination enable signal to generate the illumination signal. The illumination signal may have a signal form in accordance with the modulation signal. The illumination signal may be synchronized with the modulation signal. The illumination signal may be derived from the modulation signal and may even have the same frequency as the modulation signal, but may be phase shifted to the modulation signal. Generally, as mentioned, it is known that a ToF sensor may output an illumination signal for driving an associated illumination for performing the time-of-flight measurement and this outputted illumination signal is used in some embodiments of the present disclosure as input illumination signal.

It has been recognized that a combination of different illuminators in a time-of-flight module (ToF module) may improve a performance of the ToF module with respect to depth accuracy, depth image resolution, depth resolution range or sensitivity/robustness to ambient light.

In particular, it has been recognized that ToF systems with a full-field illuminator may provide a higher spatial resolution compared to ToF systems with a spot illuminator and that ToF systems with the spot illuminator may provide a higher depth accuracy and precision compared to ToF systems with the full-field illuminator. A spotted illumination may allow to achieve a higher signal-to-noise ratio and thus less depth noise (depth precision) and may allow to improve depth accuracy by reducing multipath interference.

Hence, it has been recognized that a ToF module, which integrates a full-field and a spot illuminator, should be provided in order to combine both measurement characteristics in a single module.

As mentioned above, however, typical ToF sensors have one control channel for controlling one illuminator and, thus, for controlling more than one illuminator with one ToF sensor, more than one control channel may be required.

However, it has further been recognized that control channels may not be synchronized among each other (e.g., when two or more modulation signals/illumination signals are generated separately) which may result in light interferences between light emitted by the different illuminators (e.g., glitching). Thus, it has been recognized that illumination signals (which control an active state and an inactive state of an illuminator such as the modulation signal) for each illuminator should be synchronized.

Hence, some embodiments pertain to an illumination circuitry for a time-of-flight module for switching at least two illuminators, wherein the illumination circuitry is configured to receive an input illumination signal from a time-of-flight sensor and to generate, based on the input illumination signal, synchronized first illumination signals for a first illuminator and second illumination signals for a second illuminator.

The illumination circuitry may be based on or may include or may be implemented by typical electronic components configured to achieve the functionality as described herein.

The illumination circuitry may be based on or may include or may be implemented by one or more flip-flop circuitries, one or more timer circuitries, one or more selectors, one or more multiplexers, one or more digital potentiometers, one or more logical circuitries (e.g., an AND-circuitry, a NAND-circuitry, an OR-circuitry, etc.) or the like.

The illumination circuitry may be based on or may include or may be implemented as integrated circuitry logic or may be implemented by a CPU (central processing unit), an application processor, a graphical processing unit (GPU), a microcontroller, an FPGA (field programmable gate array), an ASIC (application specific integrated circuit) or the like. The functionality may be implemented by software executed by a processor such as an application processor or the like. The illumination circuitry may be based on or may include or may be implemented in parts by typical electronic components and integrated circuitry logic and in parts by software. The illumination circuitry may include data storage capabilities to store data such as memory which may be based on semiconductor storage technology (e.g. RAM, EPROM, etc.) or magnetic storage technology (e.g. a hard disk drive) or the like.

The time-of-flight sensor (or module including the time-of-flight-sensor) outputs an illumination signal as the input illumination signal for the illumination circuitry for controlling light emission of at least two illuminators. As mentioned above, The illumination signal generated in the ToF sensor may be based on a (high-frequency) modulation signal corresponding to a (high-frequency) demodulation signal generated in the ToF sensor and applied to a plurality of pixels in the ToF sensor. The modulation signal may be gated with an illumination gating signal or an illumination enable signal to generate the illumination signal. The illumination signal may have a signal form in accordance with the modulation signal. The illumination signal may be synchronized with the modulation signal. The time-of-flight sensor or module may be encapsulated and may only have a single output pin for outputting the illumination signal.

In some embodiments, the time-of-flight sensor includes the illumination circuitry.

The at least two illuminators may be selected from a full-field illuminator and a spot illuminator. For example, the first illuminator is a full-field illuminator and the second illuminator is a spot illuminator. In another example, the first illuminator is a spot illuminator, and the second illuminator is a spot illuminator (the first illuminator being able to emit a first spot pattern different than a second spot pattern emitted from the second illuminator, wherein a spot density of the first and the second pattern may be different).

The first illumination signals are a plurality of signals, wherein one signal of the plurality of signals is generated on a frame or microframe basis and output for the first illuminator. Thus, the signal that is output for the first illuminator varies in time for controlling an active and inactive state of the first illuminator. The illumination circuitry may further be configured to receive a selector signal for selecting which of the first illumination signals is output at a particular frame or microframe.

The second illumination signals are a plurality of signals, wherein one signal of the plurality of signals is generated on a frame or microframe basis and is output for the second illuminator. Thus, the signal that is output for the second illuminator varies in time for controlling an active and inactive state of the second illuminator. The illumination circuitry may further be configured to receive a selector signal for selecting which of the second illumination signals is output at a particular frame or microframe.

In some embodiments, the first illumination signals are output at a first output terminal and the second illumination signals are output at a second output terminal.

The first illumination signals and the second illumination signals are synchronized with respect to the input illumination signal such that the first illumination signals and the second illumination signals have a substantially fixed timing relation.

In some embodiments, the generation of the synchronized first illumination signals and second illumination signals is triggered by the input illumination signal, thereby the first illumination signals and the second illumination signals are synchronized. For instance, a rising or falling edge of the illumination signal is used as trigger.

In some embodiments, the first and second illumination signals are each configured to control an active state and an inactive state of the first and the second illuminator, respectively, wherein the active state is controlled in accordance with the input illumination signal.

The active state of an illuminator is a state in which the respective illuminator emits light and the inactive state is a state in which no light emission from the respective illuminator occurs.

In such embodiments, the first illumination signals include, for example, a first modulation signal which has a waveform in accordance with the input illumination signal, a substantially constant signal (e.g., a low state) and the input illumination signal, wherein the first illuminator is set in the active state when the signal that is output is the first modulation signal or the input illumination signal. The active state may further be controlled based on a selector signal.

In such embodiments, the second illumination signals include, for example, a second modulation signal which has a waveform in accordance with the input illumination signal, a substantially constant signal (e.g., a low state) and the input illumination signal, wherein the second illuminator is set in the active state when the signal that is output is the second modulation signal or the input illumination signal. The active state may further be controlled based on a selector signal.

In some embodiments, the active state and the inactive state of the first illuminator and the second illuminator, respectively, is controlled on a frame or microframe basis.

In some embodiments, for iToF modules, a microframe is represented by a phase component (e.g., 0°, 90°, 180° or 270°). In some embodiments, for iToF modules, a frame is represented by a sequence of phase components which allows calculating a depth image (e.g., sequence of 0°, 90°, 180° and 270°). In some embodiments, for dToF modules, a frame is represented by ToF data in the form of a histogram which allows calculating a depth image.

In some embodiments, the ToF sensor outputs the illumination signal on a frame or microframe basis.

In some embodiments, the active state and the inactive state of the first illuminator and the second illuminator, respectively, is controlled in a sequence.

Exemplarily sequences are:

For example, one frame spotted illumination/one frame full-field illumination and so on. For example, two frames spotted illumination/two frames full-field illumination and so on. For example, four frames spotted illumination/four frames full-field illumination and so on.

For example, one microframe (e.g., phase component 1, 0°) spotted illumination/one microframe (e.g., phase component 2, 90°) full-field illumination/one microframe (e.g., phase component 3, 180°) spotted illumination/one microframe (e.g., phase component 4, 270°) full-field illumination/one microframe (e.g., phase component 1, 0°) full-field illumination/one microframe (e.g., phase component 2, 90°) spotted illumination/one microframe (e.g., phase component 3, 180°) full-field illumination/one microframe (e.g., phase component 4, 270°) spotted illumination and so on.

For example, eight frames spotted illumination/four frames full-field illumination and so on (example of an uneven sequence). For example, four frames spotted illumination/eight frames full-field illumination and so on (another example of an uneven sequence). For example, two frame spotted illumination/four frames full-field illumination (another example of an uneven sequence).

Hence, in some embodiments, the sequence is an alternating sequence, such that, in some embodiments, the sequence is an uneven sequence or an even sequence.

Some embodiments pertain to a time-of-flight module with switchable illumination for a scene, wherein the time-of-flight module includes:
a time-of-flight sensor, as discussed herein, configured to generate time-of-flight data representing a time-of-flight measurement of light reflected from the scene and to output an illumination signal for controlling the illumination for the scene;
an illumination circuitry, as discussed herein, configured to:
   receive the illumination signal from the time-of-flight sensor,
   generate, based on the illumination signal, synchronized first illumination signals for a first illuminator and second illumination signals for a second illuminator;
the first illuminator, as discussed herein, configured to:
   receive the first illumination signals,
   provide, based on the first illumination signals, the full-field illumination to the scene; and
the second illuminator, as discussed herein, configured to:
   receive the second illumination signals,
   provide, based on the second illumination signals, the spotted illumination to the scene.

The time-of-flight module may be provided on a single circuit board such that the ToF can be plugged in an embedding device or in an installation position (for example, in a vehicle for in-cabin passenger monitoring or at a front of the vehicle for environment detection). The embedding device may be a head mounted display, a virtual reality display, a security camera, a mobile device such as a laptop, a tablet, etc. The ToF module may have a connector for plugging the ToF module in a corresponding connector in the embedding device. The connector may include a data bus and the ToF module may have a data bus interface for transmitting data over the data bus to the embedding device, for example, to an application processor of the embedding device. The data bus interface may be, for example, a Camera Serial Interface (CSI) in accordance with MIPI (Mobile Industry Processor Interface) specifications (e.g. MIPII CSI-2 or the like), an I2C (Inter-Integrated Circuit) interface, a Controller Area Network (CAN) bus interface, an FDP-link (Flat Panel Display link), a GSML (Gigabit Multimedia Serial Link), etc. The data bus is in accordance with the corresponding interface specifications.

The first illuminator may be a full-field illuminator and the second illuminator may be a spot illuminator or vice versa.

The full-field illuminator may include a light source or light source elements and may include optical parts such as lenses or the like. The light source or the light source elements may be or include a laser such as a laser diode or a VCSEL (Vertical Surface Emitting Laser), a plurality of laser diodes or VCSELs which may be arranged in rows and columns as an array, a light emitting diode (LED), a plurality of light emitting diodes arranged as an array, or the like. The full-field illuminator may emit visible light or infrared light, etc.

The full-field illuminator provides a full-field illumination to a scene. The full-field illumination corresponds to a continuous spatial light profile provided to the scene.

The spot illuminator may include a light source or light source elements and may include optical parts such as lenses or the like. The light source or the light source elements may be a laser such as a laser diode, a plurality of laser diodes which may be arranged in rows and columns as an array, a light emitting diode, a plurality of light emitting diodes arranged as an array, or the like. The spot illuminator may emit visible light or infrared light, etc.

The spot illuminator provides a spotted illumination to a scene. The spotted illumination corresponds to a light pattern of (separated) high-intensity and low-intensity (or substantially zero-intensity) areas such as a pattern of light spots provided to the scene. In some embodiments, the spot illuminator provides a spatially modulated light field-of-illumination (light pattern) with vertical or horizontal stripes or with a checker pattern. Generally, in some embodiments, the spot illuminator provides a spatially modulated field-of-illumination (light pattern) to a scene where a light intensity is low (or substantially zero) in part of the light pattern.

The time-of-flight sensor may include a pixel circuitry with a plurality of pixels and read-out circuitry and optical parts such as a lens, microlenses, or the like. The plurality of pixels may be arranged in rows and columns as an array or the like. The plurality of pixels may be current assisted photonic demodulator (CAPD) pixels, single photon avalanche diode (SPAD) pixels, photodiode pixels or active pixels based on, for example, CMOS (complementary metal oxide semiconductor) technology, etc.

The ToF sensor generates time-of-flight data, which may be pixel values of each of the plurality of pixels of one or more frames or component data or a histogram. The ToF sensor outputs the time-of-flight data to a control unit or an application processor for depth information generation.

In some embodiments, light of the full-field illumination has a different wavelength than light of the spotted illumination.

This may improve the reflectivity of objects in the scene, since light sources of the two illuminators with specifically selected wavelengths (for example, selected for a specific application such as automotive applications, gaming applications, etc.) may be chosen. This may, for example, increase robustness against ambient light, improve a detection range, improve eye-safety and de-alising capabilities.

In some embodiments, the full-field illumination has a different modulation frequency than the spotted illumination. For example, by providing a frequency division circuitry for one of the two illuminators.

This may improve depth accuracy within a long distance (de-alising may be done with only one depth image) with reduced motion blur and increased frame rate.

In some embodiments, a field-of-illumination of the full-field illumination is different from a field-of-illumination of the spotted illumination.

This may reduce power consumption for specific applications/scenes, for example, due to more light at less power in specific regions of the scene.

In some embodiments, the first illuminator has a different light source type than the second illuminator.

For example, one illuminator has a light source type based on LEDs and the other one has a light source type based on VCSELs. This may provide a low-cost light source (e.g., LED) for lower accuracy and a relatively high-cost light source (e.g., VCSEL) for higher accuracy depending on, for example, specific application of the time-of-flight module.

Some embodiments pertain to an illumination method for a time-of-flight module for switching at least two illuminators, wherein the illumination method includes: receiving an input illumination signal from a time-of-flight sensor and generating, based on the input illumination signal, synchronized first illumination signals for a first illuminator and second illumination signals for a second illuminator.

The method may be performed by the illumination circuitry as described herein.

In some embodiments, the method further includes: triggering, by the input illumination signal, the generation of the synchronized first illumination signals and second illumination signals. In some embodiments, the illumination method further includes: controlling, by the first and second illumination signals, an active state and an inactive state of the first and the second illuminator, respectively, wherein the active state is controlled in accordance with the input illumination signal.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

Returning to FIG. 1, there is schematically illustrated in a block diagram an embodiment of a time-of-flight module 1, which is discussed in the following.

The time-of-flight module 1 (in the following: ToF module 1) includes a first illuminator 2, a second illuminator 3, a time-of-flight sensor 4 (in the following: ToF sensor 4), an illumination circuitry 5 and a control unit 6. In this embodiment, the illumination circuitry 5 is provided separately, however, in other embodiments, the illumination circuitry is included in the ToF sensor.

The ToF module 1 is provided as an iToF module (in other embodiments it is an dToF module).

The first illuminator 2 provides (modulated in time) full-field illumination to a scene 7 in which an object 8 is arranged.

The second illuminator 3 provides (modulated in time) spotted illumination to the scene 7.

The object 8 at least partially reflects light of the full-filed illumination or the spotted illumination towards the ToF sensor 4.

The ToF sensor 4 includes an optical lens 9 for imaging the reflected light onto an image sensor 10 for generating ToF data representing a ToF measurement of the light reflected from the scene 7.

The ToF sensor 4 further includes a data bus 11 for transmitting the generated ToF data to the control unit 6 and for receiving configuration settings from the control unit 6.

The ToF sensor 4 further includes a control channel 12 for outputting at least an illumination signal for controlling a light emission of the first illuminator 2 and second illuminator 3. The illumination signal is output at the control channel 12 on a frame or microframe basis.

The illumination circuitry 5 receives the illumination signal from the ToF sensor 4 as an input illumination signal.

The illumination circuitry 5 generates, based on the input illumination signal, synchronized first illumination signals for the first illuminator 2 and second illumination signals for the second illuminator 3, wherein the generation of the synchronized first illumination signals and second illumination signals is triggered by the input illumination signal. The first and second illumination signals are each configured to control an active state and an inactive state of the first illuminator 2 and the second illuminator 3, respectively, wherein the active state is controlled in accordance with the input illumination signal.

Specifically, the illumination circuitry 5 generates a first illumination signal which is one of a plurality of signals (first illumination signals) and the illumination circuitry 5 generates a second illumination signal which is one of a plurality of signals (second illumination signals).

The illumination circuitry 5 outputs the first illumination signal at a first output terminal to the first illuminator 2 and the second illumination signal at a second output terminal to the second illuminator 3 for controlling the active/inactive state of the respective illuminator, wherein the signal that is output at each output terminal varies in time for switching the two illuminators.

In the active state, the first illuminator 2 or the second illuminator 3 provides the full-field illumination or the spotted illumination, respectively, to the scene 7. In the inactive state, no light emission occurs from the respective illuminator.

The control unit 6 includes an image processing unit 13 and a 3D reconstruction unit 14.

The image processing unit 13 obtains the ToF data and calculates, based on the ToF data, a distance/depth information for the scene 7.

The 3D reconstruction unit 14 obtains the depth information and generates a depth map or depth image based on the depth information. In other embodiments, the ToF data is output over a data bus to an application processor for generating the depth information/map.

The control unit 6 further provides configuration settings to the two illuminators 2 and 3.

In this embodiment, the control unit 6 outputs a selector signal to the illumination circuitry 5 (indicated by the dotted line in FIG. 1) and to each of the two illuminators 2 and 3, wherein the selector signal indicates whether the illumination circuitry 5 operates in an alternating mode or not.

In other embodiments, the ToF sensor 4 outputs the selector signal at the control channel 12 to the illumination circuitry 5 and to each of the two illuminators 2 and 3.

The illumination circuitry 5 allows switching the input illumination signal or a waveform generated in accordance with the input illumination signal to each of the two illuminators 2 and 3 in a controlled and synchronized way and, thus, the illumination circuitry 5 allows controlling of more than one illuminator with one ToF sensor 4 (in particular with typical ToF sensors which have only one control channel for one illuminator).

Hence, the illumination circuitry allows switching between the two illuminators 2 and 3 without light interference of light emitted by each of the two illuminators 2 and 3.

Moreover, the illumination circuitry 5 allows reducing the number of control channels in the ToF sensor 4.

Furthermore, the illumination circuitry 5 allows controlling of the active/inactive state of each of the illuminators 2 and 3 on a frame (for all phase components) or microframe (for a phase component, e.g., 0°, 90°, 180° or 270°) basis.

Thus, the illumination circuitry 5 allows controlling the active/inactive state of the two illuminators 2 and 3 in a sequence including, for example, an alternating sequence or an uneven sequence on a frame or microframe basis.

In the alternating sequence, for example, the first illuminator 2 (full-field illuminator) provides full-field illumination to the scene 7 (active state) in a first frame or a first microframe. Then, the second illuminator 3 (spot illuminator) provides spotted illumination to the scene 7 (active state) in a second frame or a second microframe after the first frame or the first microframe, wherein the first illuminator 2 is in an inactive state (no light emission). Then, again the first illuminator 2 is in the active state and the second illuminator 3 is in the inactive state and so on.

Thereby, the depth data/depth information/depth map generated with full-field illumination and with spotted illumination, respectively, may be more comparable than in cases in which the illumination is not alternated, since the scene may change rapidly and, thus, at least slightly different scenes may be illuminated when the time between switching becomes larger.

In the uneven sequence, the number of consecutive frames or microframes in which one illuminator is in the active state and the other illuminator is in the inactive state is different. For example, two frames full-field illumination and then four frames spotted illumination. This may be configured, for example, when the SNR with spotted illumination is below a predetermined threshold and, thus, the number of frames with spotted illumination may be increased compared to frames with full-field illumination.

The sequence can also be or can include, for example, two frames full-field illumination and then two frames spotted illumination, four frames full-field illumination and then four frames spotted illumination, etc.

In addition, the two illuminators 2 and 3 can have different emission wavelengths. This can improve the reflectivity of the object 8, since light sources of the two illuminators 2 and 3 with specifically selected wavelengths (for example, selected for a specific application such as automotive applications, gaming applications, etc.) may be chosen. This can, for example, increase robustness against ambient light, improve a detection range, improve eye-safety and de-alising capabilities.

Moreover, the two illuminators 2 and 3 can have a different modulation frequency. For example, by providing a frequency division circuitry for one of the two illuminators 2 and 3. This can improve depth accuracy within a long distance (de-alising can be done with only one depth image) with reduced motion blur and increased frame rate.

Additionally, a field-of-illumination of the two illuminators 2 and 3 can be different. This can reduce power consumption for specific applications/scenes, for example, due to more light at less power in specific regions of the scene.

Furthermore, the two illuminators can have a different light source type. For example, one illuminator has a light source type based on LEDs and the other one has a light source type based on VCSELs. This allows having a low-cost light source (e.g., LED) for lower accuracy and a high-cost light source (e.g., VCSEL) for high accuracy depending on the specific application of the ToF module 1.

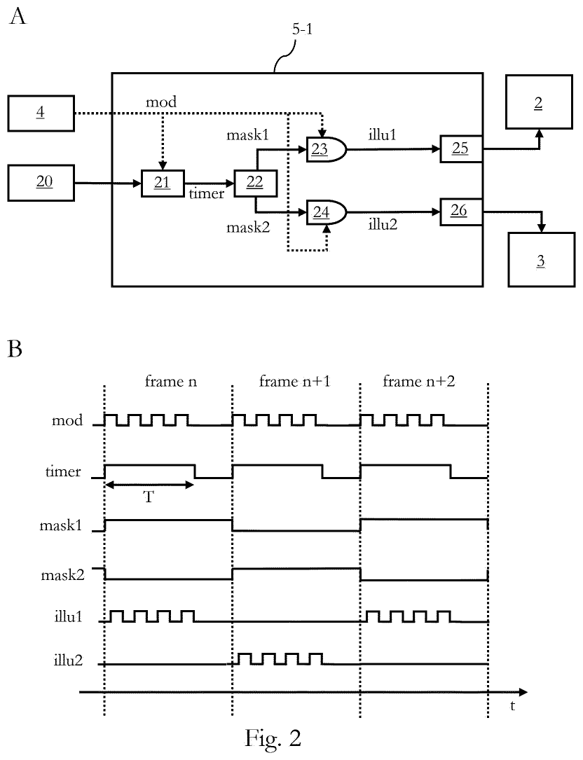

FIG. 2 schematically illustrates in FIG. 2A in a block diagram a first embodiment of an illumination circuitry 5-1 and in FIG. 2B in a timing diagram a signal timing of the first embodiment of the illumination circuitry 5-1.

The illumination circuitry 5-1, as depicted in FIG. 2A, includes a timer circuitry 21, a flip-flop circuitry 22, a first logical circuitry 23 and a second logical circuitry 24, a first output terminal 25 and a second output terminal 26.

The illumination circuitry 5-1 receives the illumination signal (mod; dotted line) as the input illumination signal from the ToF sensor 4 (e.g., the ToF sensor of FIG. 1).

The timer circuitry 21 receives the input illumination signal as a trigger for the generation of first illumination signals (illu1) and second illumination signals (illu2).

The timer circuitry 21 generates, in response to the trigger, a timer signal (timer) which has a high state for a period T.

The timer circuitry 21 receives further a configuration signal from a digital potentiometer 20 (part of the control unit 6) for adjusting a length of the period T. The length may be varied, for example, for different averaging times in a frame or microframe.

The flip-flop circuitry 22 receives the timer signal (timer) and generates a first mask signal (mask1) and a second mask signal (mask 2), wherein each of the first mask signal (mask1) and the second mask signal (mask2) has a first state and a second state (for example, a high and a low state), wherein the first mask signal (mask1) has the first state when the second mask signal (mask2) has the second state and the first mask signal (mask1) has the second state when the second mask signal (mask2) has the first state.

The first logical circuitry 23 receives the first mask signal (mask1) and the input illumination signal (mod), wherein the first logical circuitry 23 is an AND-circuitry.

The first logical circuitry 23 generates a first illumination signal which either has a signal waveform in accordance with the input illumination signal when the first mask signal (mask1) has the first state or which is substantially constant or zero when the first mask signal (mask2) has the second state.

Hence, at the first output terminal 25, first illumination signals (illu1) are output, wherein the signal that is output varies in time (on a frame or microframe basis). The first illuminator 2 is connected to the first output terminal 25.

The second logical circuitry 24 receives the second mask signal (mask2) and the input illumination signal (mod), wherein the second logical circuitry 24 is an AND-circuitry.

The second logical circuitry 24 generates a second illumination signal which either has a signal waveform in accordance with the input illumination signal when the second mask signal (mask2) has the first state or which is substantially constant or zero when the second mask signal (mask2) has the second state.

Hence, at the second output terminal 26, second illumination signals (illu2) are output, wherein the signal that is output varies in time. The second illuminator 2 is connected to the second output terminal 26.

The signal timing of the illumination circuitry 5-1 is depicted in FIG. 2B. The signal timing is controlled on a frame basis, however, in other embodiments, the signal timing is controlled on a microframe basis (phase components).

In frame n, the first mask signal (mask1) is in the first state (e.g., high) and the second mask signal (mask2) is in the second state (e.g., low) and, thus, the signal output (one of illu1) at the first output terminal 25 has a signal waveform in accordance with the input illumination signal (mod) and the signal output (one of illu2) at the second output terminal 26 is a substantially zero signal.

Hence, in frame n, the first illuminator 2 is in the active state and the second illuminator 3 is in the inactive state.

Then, in frame n+1, the first mask signal (mask1) is in the second state and the second mask signal (mask2) is in the first state and, thus, the signal output (one of illu1) at the first output terminal 25 is a substantially zero signal and the signal output (one of illu2) at the second output terminal 26 has a signal waveform in accordance with the input illumination signal (mod).

Hence, in frame n+1, the first illuminator 2 is in the inactive state and the second illuminator 3 is in the active state.

Then, in frame n+2, the first illuminator 2 is in the active state and the second illuminator 3 is in the inactive state and so on.

Thus, the active and inactive state of the first illuminator 2 and the second illuminator 3 is controlled in alternating sequence (on a frame or microframe basis). Moreover, the first and second illumination signals are synchronized with respect to the input illumination signal as the input illumination signal is used as trigger for the generation.

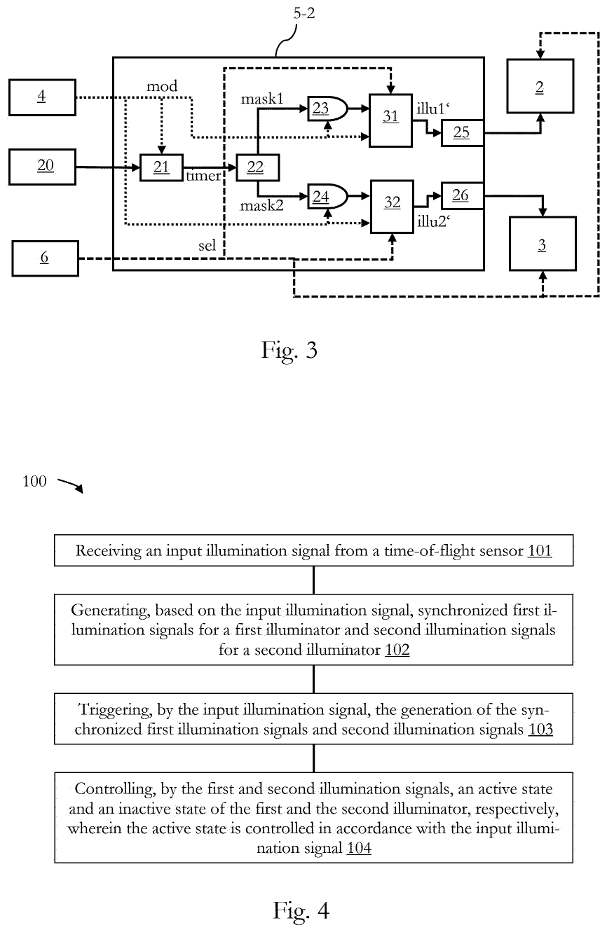

FIG. 3 schematically illustrates in a block diagram a second embodiment of an illumination circuitry 5-2.

The illumination circuitry 5-2 is based on the illumination circuitry 5-1 of FIG. 2A and, thus, a detailed description of similar components is omitted in order to avoid unnecessary repetition.

The illumination circuitry 5-2 further includes a first selector 31 and a second selector 32.

The first selector 31 receives as a first input the output of the first logical circuitry 23 and as a second input the input illumination signal (mod).

Further, the first selector 31 receives the selector signal (sel) from the control unit 6, wherein the selector signal (sel) indicates whether the first input or the second input is selected for output from the first selector 31 (illu1′).

The second selector 32 receives as a first input the output of the second logical circuitry 24 and as a second input the input illumination signal (mod).

Further, the second selector 32 receives the selector signal (sel) from the control unit 6, wherein the selector signal (sel) indicates whether the first input or the second input is selected for output from the second selector 32 (illu2′).

When the selector signal (sel) indicates that the first input is selected for output, the illumination circuitry 5-2 operates as the illumination circuitry 5-1 of FIG. 1 and the active and inactive state of the first illuminator 2 and the second illuminator 3, respectively, is controlled in an alternating sequence.

Further, the first illuminator 2 and the second illuminator 3 receive the selector signal (sel).

When the selector signal (sel) indicates that the second input is selected for output, the illumination circuitry 5-2 controls the active state and the inactive state of the first illuminator 2 and the second illuminator 3, respectively, in a sequence.

For example, the selector signal (sel) is switched from a first selector state (which indicates alternating mode) to a second state (which indicates not alternating mode), then, the illuminator, which has been lastly in the active state before switching of the selector state, stays in the active state and emits light in accordance with the illumination signal (mod), wherein the other illuminator stays in the inactive state. For example, the first illuminator 2 is in the active state before switching the selector state to the second selector state, then the first illuminator 2 stays in the active state (light emission) and the second illuminator 3 stays in the inactive state (no light emission). Then, the selector state is switched back to the first selector state for switching the active/inactive state of the illuminators such that the first illuminator 2 is in the inactive state and the second illuminator 3 is in the active state. Then, the selector state is switched back to the second selector state such that the first illuminator 2 stays in the inactive state and the second illuminator 3 stays in the active state. Of course, further switching of the state of the selector signal (sel) may follow for controlling the active/inactive state of the first/second illuminator 2/3.

Thereby, a sequence of active/inactive states of the first illuminator 2 and the second 3 can be realized such as even sequences (e.g., two frames first illuminator 2/two frames second illuminator 3).

FIG. 4 schematically illustrates in a flow diagram an embodiment of an illumination method 100.

At 101, an input illumination signal is received from a time-of-flight sensor, as discussed herein.

At 102, based on the input illumination signal, synchronized first illumination signals for a first illuminator and second illumination signals for a second illuminator are generated, as discussed herein.

At 103, the generation of the synchronized first illumination signals and second illumination signal is triggered by the input illumination signal.

At 104, an active state and an inactive state of the first and the second illuminator is controlled by the first and second illumination signals, respectively, wherein the active state is controlled in accordance with the input illumination signal, as discussed herein.

It should be recognized that the embodiments describe methods with an exemplary ordering of method steps. The specific ordering of method steps is however given for illustrative purposes only and should not be construed as binding.

Please note that the division of the control 6 into units 13 and 14 is only made for illustration purposes and that the present disclosure is not limited to any specific division of functions in specific units. For instance, the control 16 could be implemented by a respective programmed processor, field programmable gate array (FPGA) and the like.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.

(1) An illumination circuitry for a time-of-flight module for switching at least two illuminators, wherein the illumination circuitry is configured to:
receive an input illumination signal from a time-of-flight sensor; and
generate, based on the input illumination signal, synchronized first illumination signals for a first illuminator and second illumination signals for a second illuminator.

(2) The illumination circuitry of (1), wherein the generation of the synchronized first illumination signals and second illumination signals is triggered by the input illumination signal.

(3) The illumination circuitry of (1) or (2), wherein the first and second illumination signals are each configured to control an active state and an inactive state of the first and the second illuminator, respectively, wherein the active state is controlled in accordance with the input illumination signal.

(4) The illumination circuitry of (3), wherein the active state and the inactive state of the first illuminator and the second illuminator, respectively, is controlled on a frame or microframe basis.

(5) The illumination circuitry of (3) or (4), wherein the active state and the inactive state of the first illuminator and the second illuminator, respectively, is controlled in a sequence.

(6) The illumination circuitry of (5), wherein the sequence is an alternating sequence.

(7) The illumination circuitry of (5), wherein the sequence is an uneven sequence.

(8) The illumination circuitry of anyone of (1) to (7), wherein the first illumination signals are output at a first output terminal and the second illumination signals are output at a second output terminal.

(9) The illumination circuitry of anyone of (1) to (8), wherein the time-of-flight sensor includes the illumination circuitry.

(10) An illumination method for a time-of-flight module for switching at least two illuminators, wherein the illumination method includes:
receiving an input illumination signal from a time-of-flight sensor; and
generating, based on the input illumination signal, synchronized first illumination signals for a first illuminator and second illumination signals for a second illuminator.

(11) The illumination method of (10), wherein the illumination method further includes:
triggering, by the input illumination signal, the generation of the synchronized first illumination signals and second illumination signals.

(12) The illumination method of (10) or (11), wherein the illumination method further includes:
controlling, by the first and second illumination signals, an active state and an inactive state of the first and the second illuminator, respectively, wherein the active state is controlled in accordance with the input illumination signal.

(13) The illumination method of (12), wherein the active state and the inactive state of the first illuminator and the second illuminator, respectively, is controlled on a frame or microframe basis.

(14) The illumination method of (12) or (13), wherein the active state and the inactive state of the first illuminator and the second illuminator, respectively, is controlled in a sequence.

(15) The illumination method of (14), wherein the sequence is an alternating sequence or an uneven sequence.

(16) A time-of-flight module with switchable illumination for a scene, including:
a time-of-flight sensor configured to generate time-of-flight data representing a time-of-flight measurement of light reflected from the scene and to output an illumination signal for controlling the illumination for the scene;
an illumination circuitry configured to:
   receive the illumination signal from the time-of-flight sensor,
   generate, based on the illumination signal, synchronized first illumination signals for a first illuminator and second illumination signals for a second illuminator;
the first illuminator configured to:
   receive the first illumination signals,
   provide, based on the first illumination signals, the full-field illumination to the scene; and
the second illuminator configured to:
   receive the second illumination signals,
   provide, based on the second illumination signals, the spotted illumination to the scene.

(17) The time-of-flight module of (16), wherein light of the full-field illumination has a different wavelength than light of the spotted illumination.

(18) The time-of-flight module of (16) or (17), wherein the full-field illumination has a different modulation frequency than the spotted illumination.

(19) The time-of-flight module of anyone of (16) to (18), wherein a field-of-illumination of the full-field illumination is different than a field-of-illumination of the spotted illumination.

(20) The time-of-flight module of anyone of (16) to (19), wherein the first illuminator has a different light source type than the second illuminator.

(21) A computer program comprising program code causing a computer to perform the method according to anyone of (10) to (15), when being carried out on a computer.

(22) A non-transitory computer-readable recording medium that stores therein a computer program product, which, when executed by a processor, causes the method according to anyone of (10) to (15) to be performed.

1. An illumination circuitry for a time-of-flight module for switching at least two illuminators, the illumination circuitry being configured to:
receive an input illumination signal from a time-of-flight sensor; and
generate, based on the input illumination signal, synchronized first illumination signals for a first illuminator and second illumination signals for a second illuminator.

2. The illumination circuitry according to claim 1, wherein the generation of the synchronized first illumination signals and second illumination signals is triggered by the input illumination signal.

3. The illumination circuitry according to claim 1, wherein the first and second illumination signals are each configured to control an active state and an inactive state of the first and the second illuminator, respectively, wherein the active state is controlled in accordance with the input illumination signal.

4. The illumination circuitry according to claim 3, wherein the active state and the inactive state of the first illuminator and the second illuminator, respectively, is controlled on a frame or microframe basis.

5. The illumination circuitry according to claim 3, wherein the active state and the inactive state of the first illuminator and the second illuminator, respectively, is controlled in a sequence.

6. The illumination circuitry according to claim 5, wherein the sequence is an alternating sequence.

7. The illumination circuitry according to claim 5, wherein the sequence is an uneven sequence.

8. The illumination circuitry according to claim 1, wherein the first illumination signals are output at a first output terminal and the second illumination signals are output at a second output terminal.

9. The illumination circuitry according to claim 1, wherein the time-of-flight sensor includes the illumination circuitry.

10. An illumination method for a time-of-flight module for switching at least two illuminators, the illumination method comprising:
receiving an input illumination signal from a time-of-flight sensor; and
generating, based on the input illumination signal, synchronized first illumination signals for a first illuminator and second illumination signals for a second illuminator.

11. The illumination method according to claim 10, further comprising:
triggering, by the input illumination signal, the generation of the synchronized first illumination signals and second illumination signals.

12. The illumination method according to claim 10, further comprising:
controlling, by the first and second illumination signals, an active state and an inactive state of the first and the second illuminator, respectively, wherein the active state is controlled in accordance with the input illumination signal.

13. The illumination method according to claim 12, wherein the active state and the inactive state of the first illuminator and the second illuminator, respectively, is controlled on a frame or microframe basis.

14. The illumination method according to claim 12, wherein the active state and the inactive state of the first illuminator and the second illuminator, respectively, is controlled in a sequence.

15. The illumination method according to claim 14, wherein the sequence is an alternating sequence or an uneven sequence.

16. A time-of-flight module with switchable illumination for a scene, comprising:
a time-of-flight sensor configured to generate time-of-flight data representing a time-of-flight measurement of light reflected from the scene and to output an illumination signal for controlling the illumination for the scene;
an illumination circuitry configured to:
receive the illumination signal from the time-of-flight sensor,
generate, based on the illumination signal, synchronized first illumination signals for a first illuminator and second illumination signals for a second illuminator;
the first illuminator configured to:
receive the first illumination signals,
provide, based on the first illumination signals, the full-field illumination to the scene; and
the second illuminator configured to:
receive the second illumination signals,
provide, based on the second illumination signals, the spotted illumination to the scene.

17. The time-of-flight module according to claim 16, wherein light of the full-field illumination has a different wavelength than light of the spotted illumination.

18. The time-of-flight module according to claim 16, wherein the full-field illumination has a different modulation frequency than the spotted illumination.

19. The time-of-flight module according to claim 16, wherein a field-of-illumination of the full-field illumination is different than a field-of-illumination of the spotted illumination.

20. The time-of-flight module according to claim 16, wherein the first illuminator has a different light source type than the second illuminator.
